(19) United States
(12) Patent Application Publication
(10) Pub. No.: US 2014/0149285 A1
(43) Pub. Date: May 29, 2014

(54) EFFECTING PAYMENTS VIA MOBILE PHONES

(71) Applicant: INTERNATIONAL BUSINESS MACHINES CORPORATION, Armonk, NY (US)

(72) Inventors: Pradipta De, New Delhi (IN); Kuntal Dey, New Delhi (IN); Vinod V. Mankar, Bangalore (IN)

(73) Assignee: INTERNATIONAL BUSINESS MACHINES CORPORATION, Armonk, NY (US)

(21) Appl. No.: 13/689,251

(22) Filed: Nov. 29, 2012

(51) Int. Cl. G06Q 20/32

(52) U.S. Cl. CPC G06Q 20/3276
USPC 705/41

(57) ABSTRACT

Methods and systems for effecting mobile payments. A token for a payment is generated generating at a first mobile phone. The token is transferred between the first mobile phone and a second mobile phone, and is encashed at at least one of: the first mobile phone and the second mobile phone.

### BACKGROUND

Significant advances in mobile technology are leading to a renewed interest in mobile enabled financial services. Particularly, several companies worldwide have launched mobile payment services. With third party players entering the mobile wallet market, wallet-as-a-service is expected to gain more prominence. However, as none of the conventional payment systems are known to provide interoperability with respect to each other, it introduces a new inconvenience for the user.

Current mobile money deployments act as ‘walled gardens’, where a user cannot transfer money to another user or a merchant who is not registered with the same provider. Such transactions are instant and do not allow for a delayed or deferred payment. Also, conventional mobile payment systems use a human readable interchange instrument or an instrument that is not typically configured to operate on non-smart phones. Further, Near-Field Communication (NFC) technology requires two users of a mobile payment system to use mobile phones that are in close proximity so that the NFC can be used. Thus, significant inconveniences such as these have hampered many types of prospective advances to date.

### BRIEF SUMMARY

In summary, one aspect of the invention provides a method comprising the steps of: utilizing a processor to execute computer code configured to perform the steps of: generating, at a first mobile phone, a token for a payment; transferring the token between the first mobile phone and a second mobile phone; and encashing the token at at least one of: the first mobile phone and the second mobile phone.

Another aspect of the invention provides an apparatus comprising: at least one processor; and a computer readable storage medium having computer readable program code embodied therewith and executable by the at least one processor, the computer readable program code comprising: computer readable program code configured to generate, at a first mobile phone, a token for a payment; computer readable program code configured to transfer the token between the first mobile phone and a second mobile phone; and computer readable program code configured to encash the token at at least one of: the first mobile phone and the second mobile phone.

An additional aspect of the invention provides a computer program product comprising: a computer readable storage medium having computer readable program code embodied therewith, the computer readable program code comprising: computer readable program code configured to generate, at a first mobile phone, a token for a payment; computer readable program code configured to transfer the token between the first mobile phone and a second mobile phone; and computer readable program code configured to encash the token at at least one of: the first mobile phone and the second mobile phone.

A further aspect of the invention provides a method comprising: generating a token for an inter-wallet payment between a first mobile phone and a mobile destination comprising a virtual wallet, the token comprising at least one of: a quick-response code and a text representation; transferring the token between the mobile phone and the mobile destination; and encashing the token at the mobile destination.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 is an example embodiment.

FIG. 2 is an example embodiment.

FIG. 3 is a flow chart of an example embodiment.

FIG. 4 is an example embodiment.

FIG. 5 is an example embodiment.

FIG. 6 sets forth a process more generally for effecting mobile payments.

FIG. 7 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are described to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

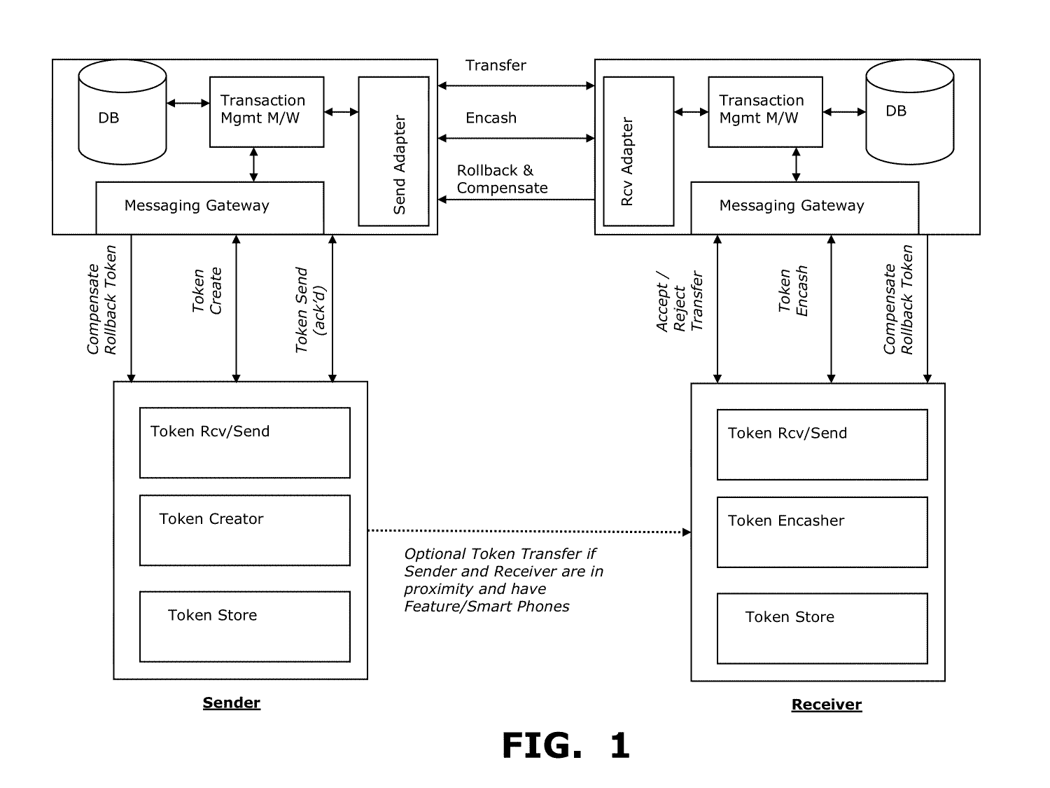

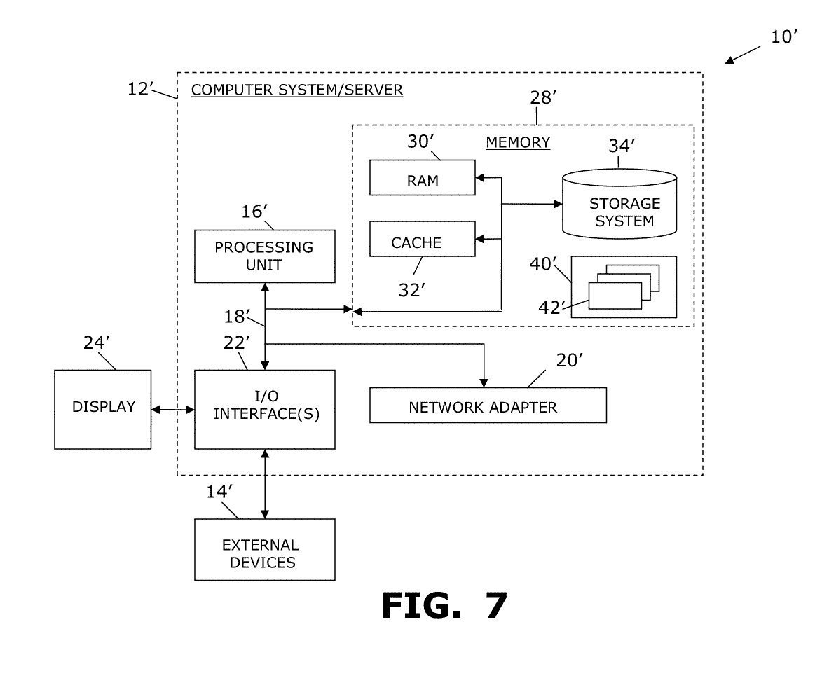

Specific reference will now be made herebelow to FIGS. 1-5. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 7. In accordance with an example embodiment, most if not all of the process steps, components and outputs discussed with respect to FIGS. 1-5 can be performed or utilized by way of a processing unit or units and system memory such as those indicated, respectively, at 16′ and 28′ in FIG. 7, whether on a server computer, a client computer, a node computer in a distributed network, or any combination thereof.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Generally, in the context of at least one embodiment of the invention, it can be recognized that challenges are met in designing an interoperable money exchange ecosystem that allows users to use wallets and interoperate seamlessly with traditional money exchange presents challenges. As such, interoperability can imply a payment artifact for money exchange representation that looks to capture details about the transactions and the parties involved. The representation can advantageously be amenable to electronic as well as traditional systems in terms of creation/procurement, transfer and encashment (i.e., consummating a monetary transaction so that one or more recipients receives actual payment). One can think of cash notes (dollar bills) and checks as examples of artifacts.

Generally, in the context of at least one embodiment of the invention, it can be recognized that there can advantageously exist a standardization for payment instruction exchange and the process of settlement. Further, a state of each transaction can desirably be maintained by all the interoperating parties, with test states maintaining at least some degree of consistency.

In accordance with at least one embodiment of the invention, interoperability involves accommodating an ecosystem where new financial players (e.g., wallets) can easily enter the process and start operating irrespective of the other parties. Such accommodation can scale linearly so that, merely by complying with the platform protocol, a new financial player does not require being registered with any other (existing) financial player to start operating.

In accordance with at least one embodiment of the invention, users are afforded an opportunity to pay with all primary money exchange modes, which includes instant exchange equivalent to cash transactions, dated exchanges equivalent to check payments and multi-transaction exchanges such as installment settlements. In addition, the receiver is provided with flexibility of withdrawing within a range of permissible dates, such as encashing a dated check on a preferred date within a specified time range rather than immediately after the check becomes valid.

In accordance with at least one embodiment of the invention, a capability is provided to use the ecosystem irrespective of the device type, including smart devices with advanced capabilities and basic devices with only plain-text format support, while being able to use any and all of these offline also. Ease-of-use (e.g., minimal keypress), reliability (e.g., consistent view of money across front-end and backend), robustness (e.g., loss or damage of device should not invalidate money) and human error tolerance (e.g., typing errors) are desirable.

In accordance with at least one embodiment of the invention, payment solutions as discussed above are unusable in absence of security, thus it is important to ensure that the ecosystem is secure and fraud-proof. Embodiments provide that the sender and the receiver of the money are front end parties. Each front end party may be associated with a backend wallet service capable of sending and receiving payments from other backend wallet services. Embodiments provide that payment instructions are captured as tokens moving across the various platform components involved in the system.

Embodiments provide for a front-end application based upon architecture, as discussed hereabove, that addresses all the money exchange modalities. A token is used in this system to represent transactions objectively across all the players participating in the money exchange process. The token is modeled as a machine-readable pictorial info-matrix code; specifically, Quick-Response (QR) code. Embodiments provide for a design that is a scalable backend in a manner that is capable of handling all the payment modalities and works for smart phones and other mobile computing devices as well as basic front-end devices. This enables basic phones (non-smart phones) and other devices with feature restrictions also to participate in this money exchange ecosystem and operate on each of the transaction modalities.

In accordance with at least one embodiment of the invention, there is afforded herein backend tracking of a token lifecycle. The system allows the sender to create and send the tokens at different times to different receivers, associating one or more validity dates and monetary values to each token. The system recognizes an explicit acceptance from the receiver before transferring the token to the receiver's account. Apart from instant exchange scenarios, where an acceptance of a token by the receiver is the only signal to encash, embodiments provide that the encashment may be initiated on the receiver's explicit expression of intent. Using third party security providers, password/PIN protection and private-public key encryption may be considered for providing security.

In accordance with at least one embodiment of the invention, it can be recognized that typical mobile wallet transactions, viewed from a user's perspectives, may be of three types. First, a user can make a payment to a merchant, as at a Point-of-Sales (PoS), or to another user, similar to a day-to-day cash transaction. These transactions are instant transactions, where the transfer happens substantially immediately. The second notion of transfer is captured by a dated check transaction, where a user marks the date of transaction. This is referred to as dated transaction, where the transfer is initiated on or after the specified date. The third form of transfer is constituted by installment payments, where on specific dates a transfer is initiated and it repeats for a pre-defined number of times. Accordingly, broadly embraced herein are wallet services that permit all three forms of transfer: instant, dated and installment. Installment payments may be embodied, as such, by equated monthly installments (EMIs), or fixed payment amounts made by a borrower to a lender at a specified date each calendar month.

Embodiments provide for digital tokens as payment instruments. The tokens are instance objects of a well-defined token class. The tokens have well-defined constructs that may specify the unique token identifier, sender, receiver, type (instant/dated/installment), and validity dates. The tokens may be represented in a machine-readable form but not necessarily human-readable form. The tokens or unique representations of the tokens may be accessed by the money sender and receiver at the front end.

Embodiments provide for a transaction management middleware at the back end for each of the sender and the receiver. The transaction management middleware may have access to a database (DB). The DB may be used for transaction state and record management purposes. The transaction management middleware may incorporate invocation of token send/receive functionalities at appropriate stages to appropriate parties. Embodiments provide that methods, such as web service API-based ones, may be defined so that a provider managing wallets can trigger add, edit, delete and query operations on another wallet and get back the results of such operations. Embodiments provide that in case where the wallet of both the sender and receiver are managed by the same provider then these databases could be the same.

In accordance with at least one embodiment of the invention, in one non-limiting example, a wallet service has a front-end hosted on the end device, and the backend, corresponding to a front-end, is hosted by a service provider with whom the user is registered. Such an arrangement is generally illustrated in FIG. 1. The front-end of the wallet service may act as the control point for three operations in the wallet service workflow: token generation, token transfer, and token encashment. Token generation is the process where a user requests for a digital token which can act as the instrument of payment, and can be easily exchanged. The sender initiates the process of token generation by sending the required information, like value, receiver name, validity dates to the backend. From a mobile phone the request is sent to a predefined short-id provided by the Mobile Network Operator. Once a token is generated by the backend, a token identifier is sent to the user and can be used subsequently to trigger transfers. Alternatively, the sender may receive the pictorial QR-coded token, which can be directly scanned by receiver from sender to trigger a transfer. In accordance with at least one implementation, the QR coded token can be transferred from the sender to the receiver in the form of a photo taken by a camera either directly or over a digital medium like email, MMS, etc. Alternatively, the sender may hand over a paper printout of the QR-coded token to the receiver to initial the transfer of the token.

In accordance with at least one embodiment of the invention, token transfer represents a process to initiate the transfer of a token generated earlier to another user. When a user wants to transfer the token, the sender sends a message to a short id with the token id to instruct transfer of the token. If the receiver is registered with the same wallet service provider as the sender, then a message is sent to the receiver to accept the token transferred to him/her. Otherwise, if the receiver is registered with a different service provider, then the sender's service provider communicates with the receiver's service provider to notify the user of the token. When the receiver acknowledges the token transfer, the sender's service provider sends a copy of the token to receiver's service provider to maintain the subsequent token states.

In accordance with at least one embodiment of the invention, token encashment represents a step when an available token is encashed. Some embodiments provide that in case of instant token types, the encashment step is initiated as soon as the token is accepted in the token transfer process. Other embodiments provide for other token types, like dated or installment, as soon as token encashment date is reached, it is available to the receiver to encash. A receiver may view all the tokens ready for encashment, and trigger encashment, leading to actual clearance of funds from sender's wallet to receiver's wallet. Embodiments provide that the encashment step may be broken into acknowledgment of token, and encashment to avoid unwarranted transfer of funds.

In accordance with at least one embodiment of the invention, an overall process is provided for as long term transactions (as opposed to instant transactions), whereby the three steps, namely token generation, transfer, and encashment, are treated as nested inner transactions. As such, each transaction rollback event may involve a compensating transaction, except when the sender fails to receive the token generated, and when a dated or installment token is not encashed within the specified date range.

Inasmuch as disruption in message delivery can represent a key source of workflow errors, and rollbacks are provided for in accordance with at least one embodiment of the invention. In accordance with non-limiting examples, related scenarios are explained next. Thus, for example, if, after token generation, the message from backend to the sender failed, the sender does not receive the token id. In this non-limiting example, the generated token is thereupon invalidated. Since the user fails to receive the token, he is expected to repeat the request for generation of the token.

In accordance with another non-limiting example, in accordance with at least one embodiment of the invention, another error state may occur when after the transfer request by sender, the token could not be delivered to the receiver. In such a case, embodiments provide that the token is marked as being cancelled, and the sender is notified of the token cancellation. Embodiments provide that the sender has the option to re-instantiate the token, if (s)he wants to attempt the transfer again to the receiver.

In accordance with another non-limiting example, in accordance with at least one embodiment of the invention, an error state may occur when, upon receiving a token, the receiver rejects the token. This may occur, for instance, if the token is wrongly delivered, or the token information, like the amount, is incorrect. Embodiments provide that the token may be invalidated and the sender notified. The sender has the option of editing the token and re-instantiating it.

In accordance with another non-limiting example, in accordance with at least one embodiment of the invention, an error state may occur when, during token encashment, the clearance from the sender's wallet fails due to an insufficient balance. Embodiments provide that, in this case, the token may be marked as not encashed. The receiver is notified of the failure and the sender is notified of the payment failure. Embodiments provide that the token may be invalidated and must be regenerated. This error may be handled like a dishonored check.

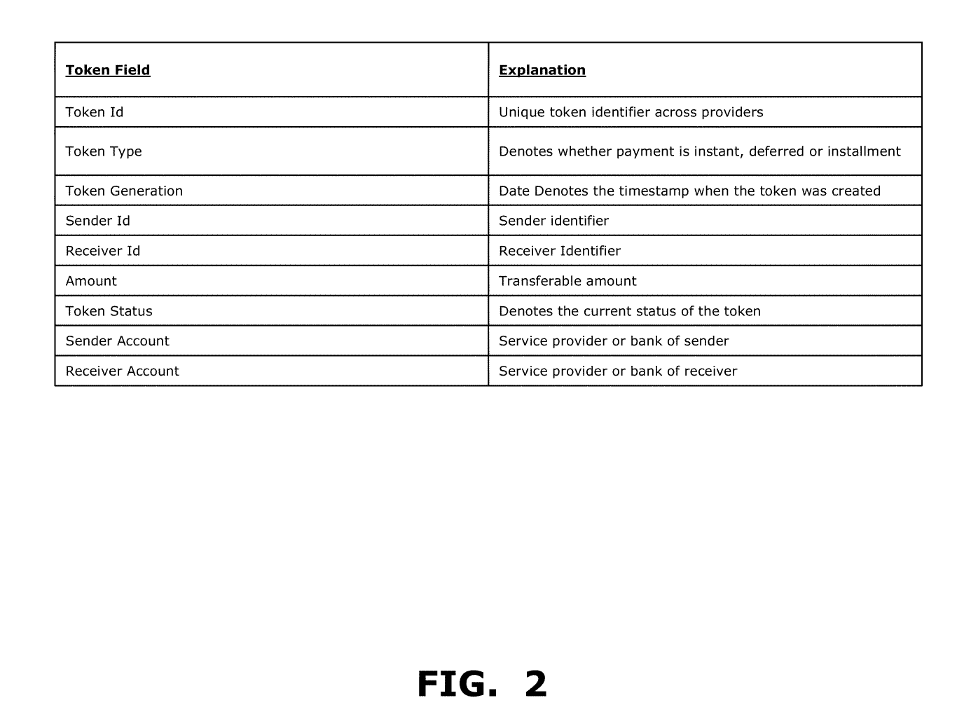

Embodiments provide for a payment system that uses QR-code tokens as the basic unit of transaction. The front-end application enables a user to transact using tokens. Embodiments provide that a token is an entity that carries the assurance of payment. A token may contain several fields. Each token may be associated with a unique identifier when it is generated. The unique identifier may be a combination of service provider id, and a unique sequence number. In one non-limiting example, if the provider id is 110, and the unique sequence number is 12345, then the token id will be 11012345. This unique id may be used to reference the token across service providers. Embodiments provide that different types of payment modes may be encoded using a type field, which denotes instant, dated or installment payment. As such, each type involves some specific fields to define it unambiguously. Embodiments provide that two other fields include sender id and receiver id. The sender and receiver's service provider id, or bank account details can be optionally present in the token. Finally, the amount to be transferred is also maintained in the token. The fields for some embodiments are summarized in the table shown in FIG. 2.

Embodiments provide that in the case of dated payment, the date from when the payment instrument is valid may also be maintained in the token, along with the validity period. In the case of an installment payment, along with the first payment date, the token may also maintain the number of payments, and payment value at each payment cycle.

In accordance with at least one embodiment of the invention, in order to maintain the lifecycle of the token, the token status is maintained at the backend. Several states are introduced which denote the current state of the token. Non-limiting examples of some states are:
1: token generated
2: token confirmed to have reached sender
3: token confirmed to have reached and accepted by receiver
4: token confirmed to have reached and rejected by receiver
5: token encashment instructed by receiver
6: token encashment completed
7: cash transfer process committed with success value and token lifecycle successfully completed, token invalidated if all sub-payments complete
8: sender receiving token process failed, rollback required
9: receiver receiving token process failed, rollback required
10: encashment transaction failed, rollback required
11: cash transfer process committed with failure value and rollback completed, token invalidated if all sub-payments complete
12+: other error states such as token mutilated, fake token presented, token claimed lost by sender/receiver etc.

In accordance with at least one embodiment of the invention, a TokenGenerated state denotes the generation of the token with the payment details sent by the sender. In this state, the token may be marked with a unique identifier and the details are embedded in a QR-code, and the token may be stored in the database of the sender's service provider. TokenDeliveredToSender denotes the state of a successful delivery of a token identifier or the QR-code representing the token to the sender. TokenAcceptedByreceiver state denotes the successful delivery and acknowledgment of receipt of the token id by the receiver when the sender has issued the transfer request to the backend.

In accordance with at least one embodiment of the invention, the sender's backend sends the token to the receiver's backend so that the token states may be maintained in a distributed manner. In one non-limiting example of an instant payment scenario, the encashment process starts immediately without an explicit request from the receiver. If the encashment succeeds, the token state moves to TokenEncashmentSucceeded.

Embodiments provide that the receiver may reject a token for various reasons, for example, the amount might be incorrect. In one non-limiting example, a token may thus be moved to a TokenRejectedByreceiver state on the receiver's backend. The state may be communicated by the backend to a sender's backend as well. Embodiments provide for other error states as well. For example, a token may be moved to the DeliveryToSenderFailure when a token is generated, but the token id cannot be delivered to the sender. This denotes a failure state, and the token can be moved to invalid or non-usable state. If a token delivery to receiver fails, then the token may be moved to the DeliveryToreceiverFailure. Embodiments provide that this error condition may lead to token invalidation. When a wallet clearance fails, viz. due to insufficient balance on the sender's wallet, then the token is moved to the state of TokenEncashmentFailure.

Embodiments provide that if the receiver requests to encash a token in his store, the specific token may be moved to TokenEncashmentRequested state. For dated or installment payment, an explicit encash request is expected. In one non-limiting example of an installment payment, the backend keeps track of partial encashments of the installments. The TokenPartEncashmentRequested state captures the receiver's intent to encash the installment payment. Continuing with this non-limiting installment payment example, the TokenPartiallyEncashed state denotes successful completion of an installment payment. The payment status of each installment may also be maintained separately in the backend databases.

Returning to the non-limiting example of an installment payment, in accordance with at least one embodiment of the invention, after the wallet balances are adjusted and the actual transfers are completed, then the token moves to the TokenEncashmentSucceeded state. This state denotes successful completion of an installment payment. Embodiments provide that in this state the token has completed its lifecycle, and can be archived.

In accordance with at least one embodiment of the invention, the sender's and receiver's wallets handshake over exposed APIs to remain synchronized about token states.

In accordance with at least one embodiment of the invention, tokens may be viewed from different mobile computing devices. In the non-limiting example of a smart phone, the user can request a QR coded image of a token and receive a QR-coded image. Also, such a user can request a QR-coded token be transformed into text and thus receive a text representation and display the text/QR code (depending upon the device capabilities).

In accordance with at least one embodiment of the invention, a smart phone or a non-smart phone (i.e., having only the ability to send and receive phone calls and SMS [short message service] text messages) and a feature phone (i.e., with limited data send and receive capabilities) may use the reference to a token (instead of the actual token) in order to carry out transactions. Some embodiments provide for sending SMS of short codes for carrying out token actions (for example, an SMS code for “token generate” or an SMS code for “token transfer from sender to receiver”, or an SMS code for “token accept by receiver” or an SMS code for “token encash” by receiver”). Embodiments provide that unstructured supplementary service data (USSD) may also be used for carrying out token actions.

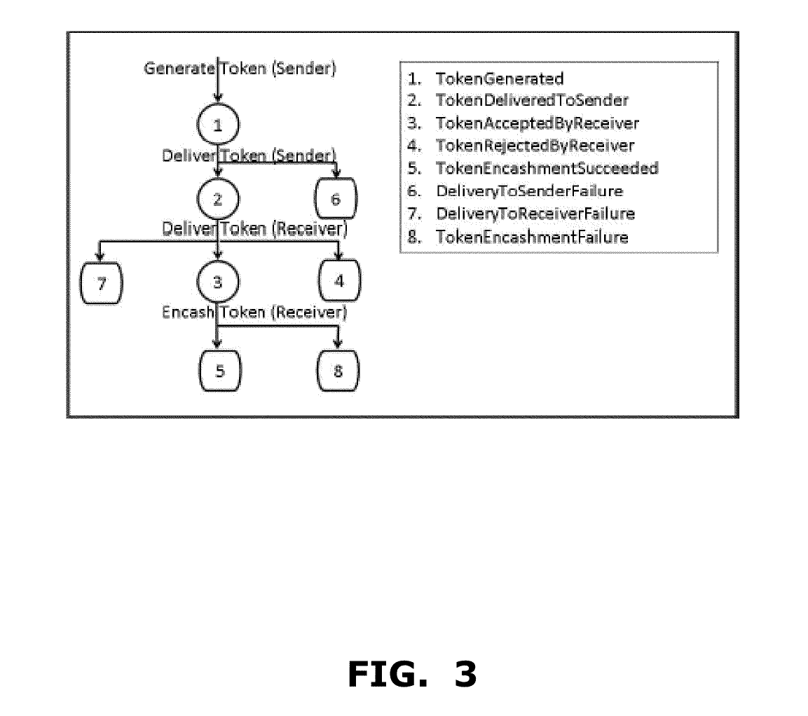

In accordance with at least one embodiment of the invention, a token creation may be described in several steps, as schematically illustrated in FIG. 3. In step 1, the sender sends an acknowledged message (e.g., SMS) to a sender's wallet provider (e.g., short code) requesting generation of a payment instruction token. The sender sends over the other details, for example, token type, payee details, amount details, validity if applicable. Embodiments provide that optionally, the send token auto-transfer indication flag may be set to true. In step 2, the backend generates the token with the details required for the transaction described in step 1. Additionally, if the payment is to be instant, available funds are verified. Embodiments provide that the this step may be integrated with checking additional alternative funding sources, for example, backup accounts, linked bank accounts, credit cards, financial loan systems. If the funds are verified during step 2, embodiments provide that a token is generated and stored locally and the token is marked as generated. In step 3, embodiments provide that the backend sends an acknowledged message to the sender (for example, SMS) which includes a reference to the token that was generated in step 3. Embodiments provide that during this step, a rollback may be needed whereby the token is marked invalid if the sender cannot be reached after multiple delivery attempts. In some embodiments, the backend may keep the token for a longer duration and the sender will able to retrieve the token ID within this longer duration and may choose to manage the token lifecycle by using or invalidating the token.

Embodiments provide for transfer of a token. First, a token transfer for a sender to a receiver may be initiated if at least one of the following conditions is true: (1) if the token auto-transfer flag is set to true, in which case, the token transfer will start without any further action from the sender once the sender receives the token; and/or (2) the sender proactively initiates the token transfer process by sending a message (SMS) to a short code of the sender's backend indicating send action and token ID. Embodiments provide that the next step in the token transfer may be that the sender's backend sends a message to the receiver's backend. The receiver's backend may then create a DB record that contains the field values of the token as sent over by the sender's backend. The receiver's backend may in turn send a message to the receiver. Embodiments provide that the transfer details may be included in the message from the receiver's backend. Embodiments provide that the receiver may have the option of accepted or rejecting the transfer. Further, embodiments provide that if the receiver cannot be reached, the process may be rolled back and the token invalidated. Embodiments provide that the receiver can optionally accept or reject the transfer. Further embodiments provide that for a receiver with a smart phone, there may be an option for responding via a listener application. Embodiments provide that for a receiver with a feature phone or smart phone, there may be an option for accessing a URL. Embodiments provide that for a receiver with a basic phone, feature phone or smart phone, there will be an option of sending an acknowledged SMS to a short code.

Embodiments provide for a token transfer acceptance by a receiver and that the field of the token may be updated to reflect the acceptance. Embodiments provide that in the case of a transfer acceptance by a receiver, the receiver's backend acknowledges the acceptance to the sender's backend. Embodiments provide that after the acceptance, the sender's backend may exchange the complete token with the receiver's backend, optionally in form of QR code. Embodiments provide that the receiver's backend DB will update all the fields of the token so the sender's and receiver's DB will have the same token locally available. Embodiments provide that the receiver may then receive the QR coded token, in form of a reference, and with suitable access options depending upon the use of a smart, feature or basic phone.

Embodiments provide that in the non-limiting example of a transfer rejection by the receiver, the process failure rollback may be triggered. In this example, the token will be marked invalid at the receiver's backend. The token state will then be cascaded to the sender's back end where the token will also be invalidated. In turn, this will be cascaded and marked invalid (optionally, with a receipt transmitted to the sender). Embodiments provide that these communications may be accomplished using acknowledged message channels (for example, acknowledged SMS).

Embodiments provide for a token encashment process to begin as soon as at least one of the following three conditions is satisfied: (1) the transfer mode is instant and receiver indicates acceptance of the transfer; (2) the receiver proactively initiates a token encashment action by explicitly communicating to a receiver's backend, and at least one date range among the array of the token date range is valid for encashment; and/or (3) the receiver proactively indicates a token encashment date by explicitly communicating to the receiver's backend, and at least one date range among the array of the token date range is valid for encashment. Embodiments provide that the encashment process involves transfer of funds from the sender's wallet to the receiver's wallet. Such a process may happen over APIs exposed to the sender's backend.

Embodiments provide that if the encashment is successful, the corresponding sub-payment element of the token is marked successful. If the encashment transaction fails, the corresponding sub-payment element of the token is marked as failed and the process failure rollback is triggered. A cascading rollback process is initiated to rewind to the initial state. Embodiments provide that this rollback process may involve carrying out compensating transactions. A record of each step may be maintained both at the sender's end and the receiver's end.

Embodiments provide that if the process fails because the token could not be delivered to the sender, then the token creation is rolled back and the token is marked invalid. Embodiments provide that if the process failure occurs because the token could not be delivered to receiver, then the token creation is rolled back and the token may be marked invalid in the sender's backend and in receiver's backend if the token had reached the receiver's backend. Also, the sender may be sent a compensating token marking invalidation of the original token. Embodiments provide that if the process failure occurs because the token was rejected by receiver, the token creation is rolled back and the token may be marked invalid both in the sender and the receiver backend. Also, the sender may be sent a compensating token marking the invalidation of the original token. Embodiments provide that the backend of the receiver may optionally receive a compensating token from the backend of sender.

Embodiments provide that if the Process failure occurs because the token encashment process fails then a compensating token may be sent to both the sender and the receiver both from the sender's and the receiver's backends. Also, the status of this sub-payment may be marked as a failure and committed to the respective databases of the sender and the receiver. The token may be invalidated if all the sub-payments in this array of payments have been carried out.

Embodiments provide that if the process is successfully completed then the sender and receiver commit token status success in their respective DB and a rollback is not required. Also, the token is invalidated if all sub-payments in this array of payments have been carried out.

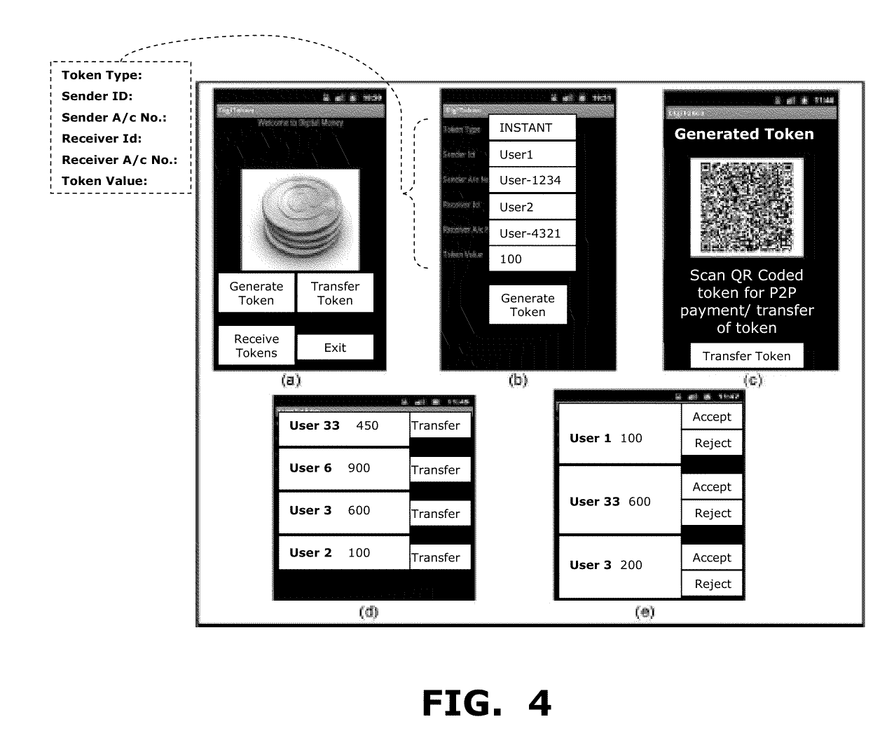

Turning now to FIG. 4, the lifecycle of a token for an instant payment scenario is illustrated. In this non-limiting example, a sender requests a token to be generated by (a) using a front-end app on a smartphone to request a new token, or (b) send an SMS to a pre-defined SMS short code. Embodiments provide that once a token is generated, the token id is delivered to the sender, indicating that a token is ready for transfer. During transfer the token id is checked by the sender's service provider, and receiver's service provider is contacted to notify the receiver. Embodiments provide that in an instant payment, the encashment step is triggered as soon as the receiver accepts a token. For dated and installment mode, the encashment is explicitly requested by the receiver. Embodiments provide that in the fund clearance process, the service provider of the receiver determines the service provider of the sender by extracting the unique provider identification number from the token id. A clearance request may be raised to the sender's service provider by the receiver's service provider indicating the token id. Embodiments provide that once the tokens are identified, and the token validity established, then the actual clearance may be performed where the wallet balance of the sender is deducted and the same amount is added to the wallet balance of the receiver.

Embodiments provide that delivering a QR-coded token instead of just a token id allows additional flexibility to the sender to transfer a token directly to a receiver. In one non-limiting example, a receiver scans the token from the sender's device. The token is parsed on the receiver's device to match the receiver id in the token. The receiver then sends a message to the backend acknowledging token receipt.

Embodiments provide that transfer of a token from the backend to an end device can be performed over MMS (multimedia messaging service). In most countries, MMS costs more than SMS. Any telecom provider supports SMS. The QR-coded token is encapsulated over multiple SMS messages. The SMS messages may be marked with a sequence number and a type code that can be deciphered at the device end and the SMS messages are merged to regenerate the QR-coded token.

A QR-code is typically a black and white pictorial representation. Therefore, it is possible to deliver the complete pixel information as a bitmap. However, the number of bytes to send will be high, leading to large number of SMSs. Embodiments provide that an optimized delivery mechanism is possible due to the structure of QR-codes. QR-codes comprise modules, where the modules are black or white. The number of modules presented depends on the content length and the level of error correction. A higher version QR-code which encapsulates more content has more modules. Typically, the number of modules in a QR-code can be computed as modules=4v+17, where v is the QR-code version number which can vary from 1 to 40 as per standards. If the module information is transmitted, then the QR-code can be reconstructed. Embodiments provide for deciphering the bit matrix representing the QR-code module information and sending the bit matrix to the sender from the backend.

In one non-limiting example, a front-end app is demonstrated as an “Android”™ based smartphone app, but other software operable by mobile phones and mobile computing devices are equally applicable to embodiments. Turning now to FIG. 4, a non-limiting example of execution steps for an instant payment are illustrated. In this example, the sender and receiver maintain wallets on two different service providers. FIG. 4-(a) shows the screen pulled up by sender in order to begin a payment. The Generate token option leads to the screen shown in FIG. 4-(b), which requires the different fields necessary for generating a token. Once the values are submitted, a token is generated and delivered to the user. FIG. 4-(c) shows the QR-coded token. In this non-limiting example, the Sender has the option to review all tokens ready for transfer, as shown in FIG. 4-(d). Once the token transfer is initiated, the backend notifies the receiver. The receiver can take a look at all tokens available to him, as shown in FIG. 4-(e). Once (s)he accepts a token, the encashment process is initiated in case of instant transfer mode.

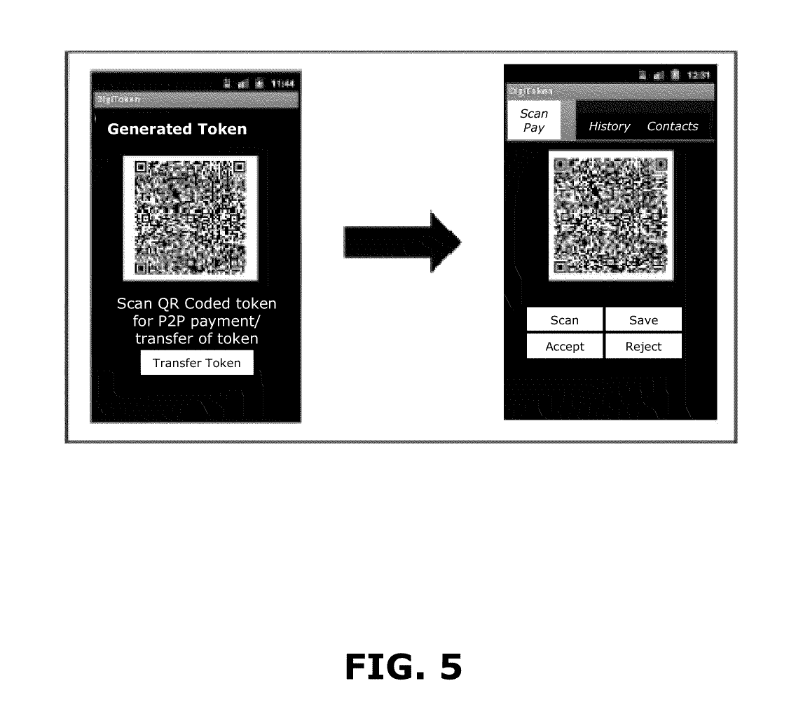

Another non-liming example of an alternative transfer mode, in accordance with at least one embodiment of the invention, is demonstrated in FIG. 5. In this mode, the sender displays the token to be transferred to the receiver. The receiver scans the token using the front-end app on his device, and the transfer process is complete. The receiver can now accept the token, and the backend is updated.

In another non-limiting example, an instant payment may be transferred from a basic phone to a smart phone. In this example, S (the sender) uses a basic phone and R (the receiver) uses a smart phone. S sends a token creation request to S's backend B(S), indicating instant pay and the details of S and R, by sending a message to short code. Next, the balance (funds) of S are checked, and if found okay then a token is created. A DB entry of the token is made The token reference is sent over to S over a message from B(S), Next, S sends a message to the backend B(S) including reference to the token indicating initiation of a transfer action. B(S) then sends a message to the backend of R, B(R), with the token ID, token type, validity date, receiver details and token's full monetary value. Next, B(R) creates a DB entry and forwards the details to R over a message. Next, in this non-limiting example, R accepts using a listener app, or accessing a URL provided in the message, or by responding with a message indicating acceptance. B(R) notifies B(S) of the acceptance and in response B(S) sends over the full token, including an objectified representation such as a QR code, to B(R). B(R) then updates its DB. R can now optionally request that the (possibly QR-coded) token be delivered to himself. Finally, in this non-limiting example embodiment, the encashment phase is provided. Here, the transfer mode is instant and the receiver has already accepted the token. Hence, the encashment process will start without any further action from S or R(B); it now settles the transaction with S(B) using APIs exposed by S(B) and R(B). A settlement acknowledgement is sent to S from B(S) and sent to R from B(R).

In another non-limiting example embodiment, S uses a smart phone to send a deferred payment to R on a smart phone. S sends a token creation request to its backend B(S), indicating a “deferred pay” and the details of S and R, by sending a message to short code. A token is created in B(S). A DB entry of token is made. A token reference is sent over to S over message from B(S). Embodiments provide that since S is on a smart phone, S can optionally request that the (possibly QR-coded) token be delivered to himself. Next, S sends a message to backend B(S) including either the token or reference to the token indicating initiation of a transfer action. B(S) then sends a message to backend or R, B(R), with the token ID, token type, validity date, receiver details and token's full monetary value. B(R) then creates a DB entry and forwards the details to R over a message.

Continuing with the non-limiting example, the transfer mode is deferred, so R has to either proactively initiate token encashment by explicitly sending a message to B(R) or by indicating the date of encashment to B(R) via explicit communication. R(B) now settles the transaction with S(B) using APIs exposed by S(B) and R(B). Settlement acknowledgement is sent to S from B(S) and sent to R from B(R).

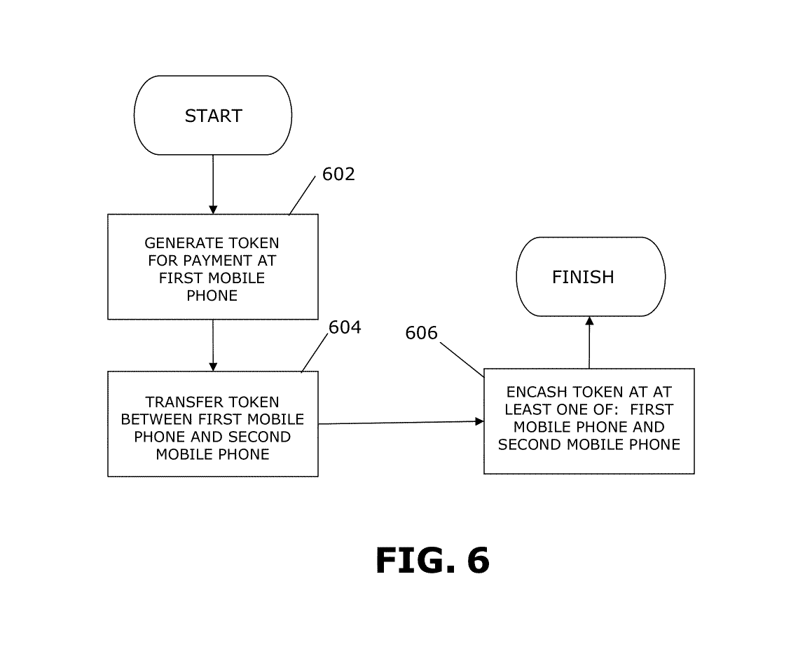

FIG. 6 sets forth a process more generally for effecting mobile payments, in accordance with at least one embodiment of the invention. It should be appreciated that a process such as that broadly illustrated in FIG. 6 can be carried out on essentially any suitable computer system or set of computer systems, which may, by way of an illustrative and non-restrictive example, include a system such as that indicated at 12′ in FIG. 7. In accordance with an example embodiment, most if not all of the process steps discussed with respect to FIG. 6 can be performed by way of a processing unit or units and system memory such as those indicated, respectively, at 16′ and 28′ in FIG. 7.

As shown in FIG. 6, in accordance with at least one embodiment of the invention, a token for a payment is generated generating at a first mobile phone (602). The token is transferred between the first mobile phone and a second mobile phone (604), and is encashed at at least one of: the first mobile phone and the second mobile phone (606).

Referring now to FIG. 7, a schematic of an example of a cloud computing node is shown. Cloud computing node 10′ is only one example of a suitable cloud computing node and is not intended to suggest any limitation as to the scope of use or functionality of embodiments of the invention provided herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be provided in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

It will be appreciated the described embodiments enable inter-wallet operations and provide for transparent seamless transactions. Moreover, embodiments provide for seamless integration of digital wallets with banking and traditional financial systems, leading to enhanced payment solutions and enhanced banking solutions. Embodiments provide for a contactless point of sale transaction. Embodiments provide for auditable and recorded digital instrument token and allow simpler clearances of high-value transactions.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are provided herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture. Such an article of manufacture can include instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and provided in order to explain principles and practical application, and to enable others of ordinary skill in the art to understand the disclosure.

Although illustrative embodiments of the invention have been provided herein with reference to the accompanying drawings, it is to be understood that the embodiments of the invention are not limited to those precise embodiments, and that various other changes and modifications may be affected therein by one skilled in the art without departing from the scope or spirit of the disclosure.

1. A method comprising the steps of:
utilizing a processor to perform the steps of:
arranging, at a first mobile phone, generation of a token for a payment;
transferring the token between the first mobile phone and a second mobile phone;
encashing the token at at least one of: the first mobile phone and the second mobile phone;
said encashing comprising arranging a receipt of payment corresponding to the token; and
maintaining a status of the token at a back end of at least one of the first mobile phone and the second mobile phone.

2. The method of claim 1, wherein the payment comprises at least one member selected from the group consisting of: an instant payment, a dated payment, and an installment payment.

3. The method of claim 2, wherein:
the at least one member comprises an installment payment; and
the installment payment comprises an equated monthly installment payment.

4. The method of claim 1, wherein said arranging comprises arranging generation, in the token, of a plurality of fields which indicate: a type of payment, a unique token identifier, a token generation timestamp, a sender identifier, a receiver identifier, a monetary transfer amount, and a current status of the token.

5. The method of claim 1, wherein the token is machine readable.

6. The method of claim 1, wherein said arranging comprises arranging generation of the token in response to a short message service message.

7. The method of claim 1, wherein the token comprises a quick-response code.

8. The method of claim 1, wherein the payment is an inter-wallet payment.

9. The method of claim 1, wherein said transferring comprises accessing the token at at least one of: a sender front end and a receiver front end.

10. The method of claim 1, wherein:
said transferring comprises effecting communication of payment details from a back end of the first mobile phone to a back end of the second mobile phone; and
said maintaining comprises designating a status of the token from an available group of token states, the available group of token states including: token generated, token confirmed to have reached sender, token confirmed to have reached and accepted by receiver, token confirmed to have reached and rejected by receiver, token encashment instructed by receiver, and token encashment completed.

11. The method of claim 1, wherein said transferring comprises transferring a text representation of the token.

12. An apparatus comprising:
at least one processor; and
a not only propagating computer readable storage medium having computer readable program code embodied therewith and executable by the at least one processor, the computer readable program code comprising:
computer readable program code configured to cause a processor to arrange, at a first mobile phone, generation of a token for a payment;
computer readable program code configured to cause a processor to transfer the token between the first mobile phone and a second mobile phone;
computer readable program code configured to cause a processor to encash the token at at least one of: the first mobile phone and the second mobile phone;
wherein to encash comprises arranging a receipt of payment corresponding to the token; and
computer readable program code configured to cause a processor to maintain a status of the token at a back end of at least one of the first mobile phone and the second mobile phone.

13. A computer program product comprising:
a not only propagating computer readable storage medium having computer readable program code embodied therewith, the computer readable program code comprising:
computer readable program code configured to cause a processor to arrange, at a first mobile phone, generation of a token for a payment;
computer readable program code configured to cause a processor to transfer the token between the first mobile phone and a second mobile phone;
computer readable program code configured to cause a processor to encash the token at at least one of: the first mobile phone and the second mobile phone;
wherein to encash comprises arranging a receipt of payment corresponding to the token; and
computer readable program code configured to cause a processor to maintain a status of the token at a back end of at least one of the first mobile phone and the second mobile phone.

14. The computer program product of claim 13, wherein the payment comprises at least one member selected from the group consisting of: an instant payment, a dated payment, and an installment payment.

15. The computer program product of claim 13, wherein said computer readable program code is configured to cause a processor to arrange, in the token, generation of at least one field which indicates a type of payment.

16. The computer program product of claim 13, wherein the token is machine readable.

17. The computer program product of claim 13, wherein said computer readable program code is configured to cause a processor to arrange generation of the token in response to a short message service message.

18. The computer program product of claim 13, wherein the token comprises a quick-response code.

19. The computer program product of claim 13, wherein said computer readable program code is configured to cause a processor to transfer a text representation of the token.

20. A method comprising:
utilizing a processor to perform the steps of:
generating a token for an inter-wallet payment between a first mobile phone and a mobile destination comprising a virtual wallet, the token comprising at least one of: a quick-response code and a text representation;
transferring the token between the mobile phone and the mobile destination;
encashing the token at the mobile destination;
said encashing comprising arranging a receipt of payment corresponding to the token; and
maintaining a status of the token at a back end of at least one of the mobile phone and the mobile destination.
